(19) United States
(12) Patent Application Publication
(10) Pub. No.: US 2007/0054687 A1
(43) Pub. Date: Mar. 8, 2007

(54) Device and method for sending information on push-to-talk groups

(75) Inventors: Kenichi Akita, Osaka (JP); Yamato Sakurai, Osaka (JP); Koujiro Seto, Osaka (JP); Ryoji Yagi, Osaka (JP); Junji Takezaki, Osaka (JP); Takao Inaguma, Osaka (JP); Takaya Nomura, Osaka (JP); Makoto Nagaki, Osaka (JP); Shinji Yamada, Osaka (JP); Masafumi Maekawa, Osaka (JP); Futoshi Nakamori, Osaka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/346,244

(22) Filed: Feb. 3, 2006

(30) Foreign Application Priority Data
Sep. 1, 2005 (JP) 2005-253156

(51) Int. Cl. H04B 7/00; H04Q 7/20

(52) U.S. Cl. 455/518

(57) ABSTRACT

A push-to-talk data transmission device that creates and manages groups of participating terminals dynamically. A PoC data transmission device is deployed to support push-to-talk sessions in a prescribed area. This device has a data transmitter that broadcasts a group profile repetitively in the prescribed area. The group profile is a set of parameters that prompt terminals in the prescribed area to send back their respective unique identifiers to join a push-to-talk session. A counter in the PoC data transmission device counts the number of responses returned from the terminals, and the data transmitter broadcasts a new group profile if the number of responses has reached a predetermined threshold.

### CROSS-REFERENCE TO RELATED APPLICATIONS

This application is based on, and claims priority to, Japanese Application No. 2005-253156, filed Sep. 1, 2005, in Japan, and which is incorporated herein by reference.

### BACKGROUND OF THE INVENTION

1. Field of the Invention

The present invention relates generally to a device and method for sending information in a mobile communications system, and particularly to a device and method for distributing information on push-to-talk groups.

2. Description of the Related Art

The Push-to-Talk over Cellular (PoC) technology enables telephone service users to communicate by using their mobile phones like walkie-talkies (see, for example, PCT Application Publication No. 2003-526275). Besides allowing one-to-one communication, the PoC network offers one-to-many talk sessions (or group calls) by defining a group of destination users. That is, it is possible to deliver the same information to a plurality of mobile phones at the same time. This push-to-talk technology is expected to enable communication carriers to develop a conspicuously new, large market of voice services. PoC service is also beneficial to subscribers because of its high cost-effectiveness. This advantage is brought by the use of data communications networks, as opposed to plain old circuit-switching networks, to carry voice information.

As seen from the above, the most attractive feature of PoC service is that it offers group call capabilities at low costs. To make this service successful, it is important to provide a convenient way of defining groups for one-to-many talk sessions.

FIG. 17 provides an overview of a group call method according to a conventional PoC technique. The system illustrated in FIG. 17 includes a group list management server (GLMS server) 91 managing a group list and presence status of users. Also involved is a PoC server 92 providing PoC control and administration services, including group membership management. A session initiation protocol (SIP) server 93 serves as an intermediary between PoC clients in establishing talk sessions or the like.

There is a registered call group 99 including PoC terminals 94 and 95 as member user stations. Suppose now that a new PoC terminal 96 is attempting to join the group 99, as indicated by the dotted arrow in FIG. 17. The following is a typical grouping process using PoC functions:

First, the user of the PoC terminal 96 asks the GLMS server 91 to provide a group list (step S101). The group list tells which groups the user can join. The user then selects a desired group out of the received group list, which triggers the PoC terminal 96 to make access to the GLMS server 91 for registration (step S102). The user operates his/her PoC terminal 96 to register it with the GLMS server 91 (step S103). The PoC terminal 96 is now a member of the call group 99 (step S104).

As can be seen from the above, the conventional grouping method requires the user of each PoC terminal to request group information, select a group, and register his/her terminal to join the selected group. This conventional method, however, has to define beforehand the membership of groups. The conventional method is inconvenient in the case where the membership of a group varies frequently, or where the groups themselves vary frequently, since users have to determine which group to join. It is also a problem from the viewpoint of group management that the users can freely select a group to join.

### SUMMARY OF THE INVENTION

In view of the foregoing, it is an object of the present invention to provide a push-to-talk data transmission device and method that can create and manage groups of participating terminals dynamically.

To accomplish the above object, the present invention provides a device for distributing data for setting up push-to-talk sessions. This device has a data transmitter to broadcast a group profile repetitively in a prescribed area. Here the group profile is a set of parameters that prompt terminals in the prescribed area to send back their unique identifiers to join a desired push-to-talk session. The device also has a counter to count the number of responses returned from those terminals. The data transmitter watches this counter, and it broadcasts a new group profile if the number of responses has reached a predetermined threshold.

In addition, to accomplish the above object, the present invention provides a method for distributing data for setting up push-to-talk sessions. This method includes the step of broadcasting a group profile repetitively in a prescribed area, where the group profile is a set of parameters that prompt terminals in the prescribed area to send back their unique identifiers to join a push-to-talk session. The method counts the number of responses returned from the terminals and broadcasts a new group profile if the number of responses has reached a predetermined threshold.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows the concept of a PoC data transmission system in which the present invention is embodied.

FIG. 2 is a block diagram of a PoC data transmission system.

FIG. 3 shows an example hardware platform for a PoC data transmission device.

FIG. 4 is a block diagram of a PoC data transmission device.

FIG. 5 shows a group ID response count table.

FIG. 6 shows a caller privilege management table.

FIG. 7 shows a GLMS data table.

FIG. 8 is a block diagram of a PoC terminal.

FIG. 9 is a plan view of a PoC terminal.

FIG. 10 is a block diagram of a group list management server.

FIG. 11 shows a device data table.

FIG. 12 shows a PoC group management table.

FIG. 13 is a flowchart showing an initial sequence of a PoC data transmission system.

FIG. 14 shows an operation sequence of a PoC data transmission system according to a first embodiment.

FIG. 15 is a flowchart showing how the PoC data transmission device behaves when a PoC terminal moves to area.

FIG. 16 shows an operation sequence of a PoC data transmission system according to a second embodiment.

FIG. 17 provides an overview of a group call method according to a conventional PoC technique.

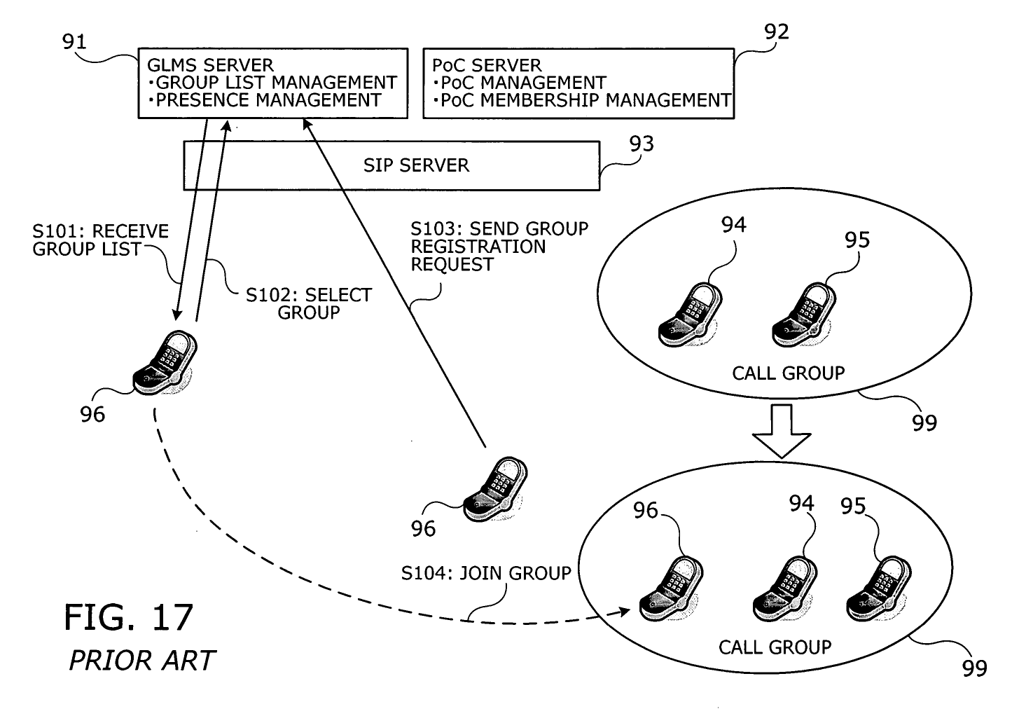

### DESCRIPTION OF THE PREFERRED EMBODIMENTS

Preferred embodiments of the present invention will now be described in detail below with reference to the accompanying drawings, wherein like reference numerals refer to like elements throughout. The description begins with an overview of the invention and then proceeds to a more specific embodiment of the invention.

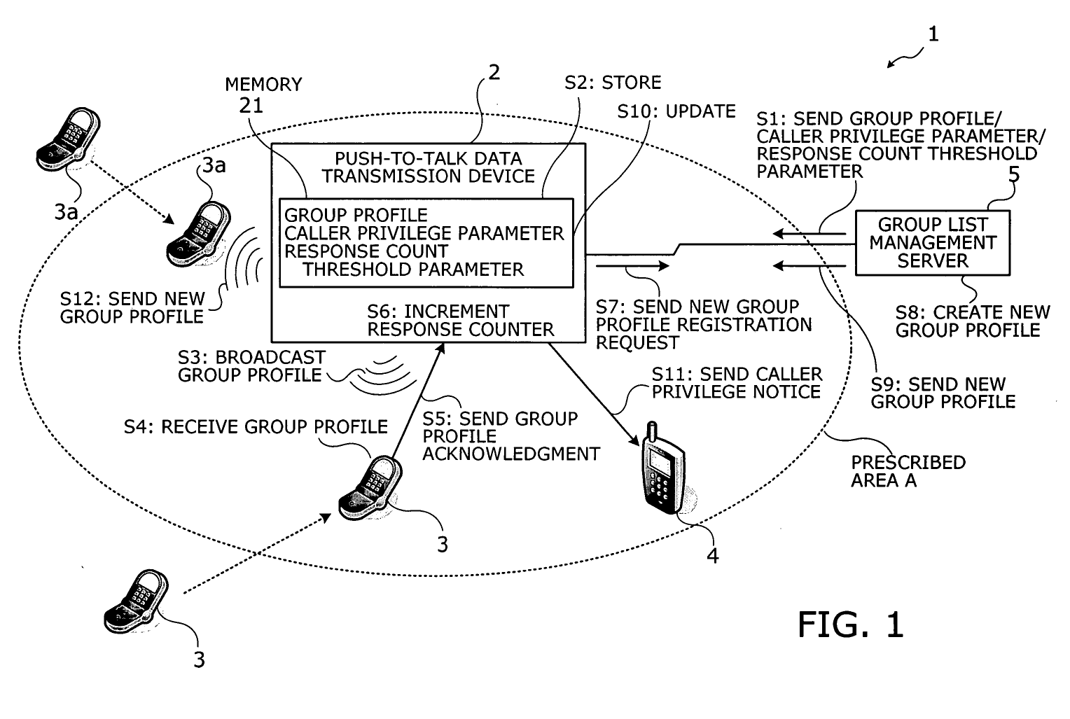

FIG. 1 shows the concept of a PoC data transmission system 1 in which the present invention is embodied. The illustrated PoC data transmission system 1 is formed from a push-to-talk data transmission device (hereinafter, “PoC data transmission device”) 2, a push-to-talk terminals (hereinafter, “PoC terminals”) 3 and 3a, an administrator terminal 4 and a group list management server 5. The PoC terminals 3 and 3a are wireless stations with push-to-talk communication functions. The administrator terminal 4 is used by an administrator who manages those PoC terminals 3 and 3a participating in a push-to-talk call session. The group list management server 5 is configured to communicate with the PoC terminals 3 and 3a.

The PoC data transmission device 2 broadcasts a group profile in a prescribed area A (also referred to as a group list broadcast area). To this end, the PoC data transmission device 2 has, among others, a memory 21 for storing group profiles, caller privilege parameters, and response count threshold parameters. A group profile is a set of parameters that prompt PoC terminals in the prescribed area to send their unique identifiers. If registered, the participating PoC terminals form a group that can be uniquely identified by the group profile information. Caller privilege parameters are transmitted to the administrator terminal 4 for use by the administrator to identify a group created by the PoC data transmission system 1. A response count threshold parameter specifies a threshold of the number of responses received, the details of which will be described later.

While FIG. 1 does not explicitly show, the PoC data transmission device 2 also has a data transmitter to broadcast group profiles and a counter to count the number of responding PoC terminals 3 and 3a. Upon receipt of a group profile, the PoC terminal 3 and 3a enters a state where it can send a group profile acknowledgment if their user wishes to enroll in the group specified by the received group profile. If this is the case, the transmitted group profile acknowledgment reaches the PoC data transmission device 2, and the requesting PoC terminal 3 and 3a also interacts with the group list management server 5 to join the group.

The administrator terminal 4 is entitled to communicate with every other PoC terminal in the same group using PoC protocols. The PoC terminals 3 and 3a, on the other hand, are ordinary members in that group, only allowed to communicate with the administrator terminal 4 through PoC.

The group list management server 5 receives information that the PoC terminals 3 and 3a submit when they are instructed to do so. The group list management server 5 manages such information for each individual group. The group list management server 5 also provides the PoC data transmission device 2 with group profiles, caller privilege parameters, and response count threshold parameters. The group list management server 5 is notified of an event that the number of responding terminals (or equivalently the number of responses received) has reached a predetermined response count threshold. This event causes the group list management server 5 to create a group profile for a new group and send it to the PoC data transmission device 2.

The above-described PoC data transmission system 1 operates as follows. First, the group list management server 5 sends a particular group profile, caller privilege parameter, and response count threshold parameter to the PoC data transmission device 2 (step S1). The PoC data transmission device 2 saves received information in its local memory 21 (step S2) and then begins broadcasting the group profile in the prescribed area A (step S3) to invite mobile users.

Then a PoC terminal 3 entering the prescribed area A receives this group profile (step S4). The PoC data transmission device 2 receives a group profile acknowledgment from this PoC terminal 3, which indicates that the user wishes to enroll in the group (step S5). The received acknowledgment causes the PoC data transmission device 2 to increment the response counter by one (step S6). If the resulting new response count equals the response count threshold given at step S1, the PoC data transmission device 2 issues a request for registration of a new group profile to the group list management server 5 (step S7). This request is also referred to as a “threshold crossing notice” since it is generated when the response counter reaches a given threshold.

The group list management server 5 creates a new group profile accordingly (step S8) and sends it back to the PoC data transmission device 2 (step S9). The PoC data transmission device 2 switches to the received new group profile (step S10) and sends the new group profile to the administrator terminal 4 (step S11). Here the PoC data transmission device 2 identifies this privileged administrator terminal 4 by consulting the caller privilege parameter received at step S1. The PoC data transmission device 2 now begins broadcasting the new group profile in area A (step S12). Afterwards another PoC terminal 3a comes into area A. This PoC terminal 3a then receives the group profile updated at step S10 and follows the same procedure.

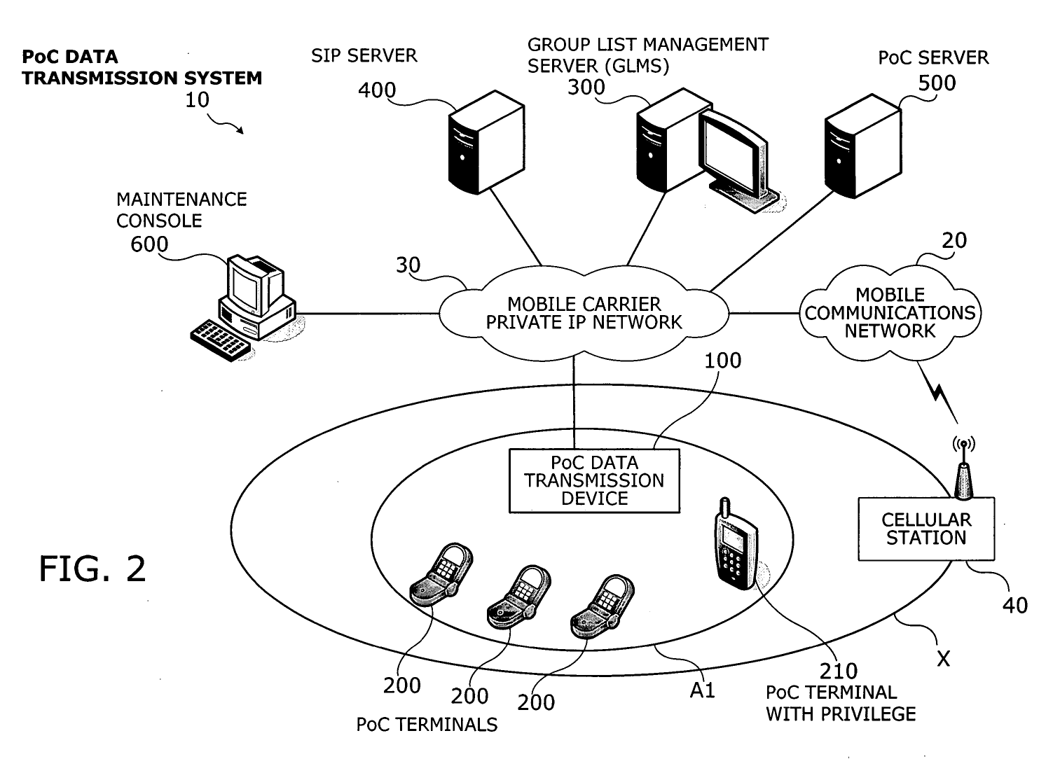

The above-described PoC data transmission device 2 counts the number of responses independently of other tasks related to group registration. It sends a new group profile when the response counter reaches a predetermined threshold, thereby enabling dynamic generation of group profiles. More specific embodiments of the present invention will now be described in detail below with reference to FIG. 2 and subsequent drawings.

FIG. 2 is a block diagram of a PoC data transmission system. This PoC data transmission system 10 involves a mobile communications network 20 and a mobile carrier private IP network 30 connected to it. The mobile communications network 20 is linked to a cellular station 40 that serves mobile stations including PoC terminals 200 and 210 in a cell area X. A PoC data transmission device 100 is deployed in this cell area X. The PoC terminals 200 and 210 are visiting the radio coverage area A1 of the PoC data transmission device 100.

There are several servers linked to the PoC data transmission device 100 via the mobile carrier private IP network 30. They are: a group list management server 300, an SIP server 400, and a PoC server 500. Further connected to the mobile carrier private IP network 30 is a maintenance console 600 for network management purposes.

The PoC terminals 200 and 210 are hybrid devices that have, for example, an infrared and/or Bluetooth (registered trademark of Bluetooth SIG, Inc.) interface for access to a wireless local area network (LAN), besides functioning as a terminal station in a mobile communications network. The PoC terminal 210 is supposed to reside in area A1, and it has a caller privilege (described later) granted from the PoC data transmission device 100 through a caller privilege notice. This PoC terminal 210 can also receive and store group IDs sent from the PoC data transmission device 100. The bearer of the PoC terminal 210 is, for example, a person who manages the area A1.

The group list management server 300 is connected to the PoC data transmission device 100 via the mobile carrier private IP network 30. Upon request from the PoC data transmission device 100, the group list management server 300 provides group IDs, caller privilege parameters, response count threshold parameters, and other information, as will be described later.

The SIP server 400 plays a role of an intermediary between each PoC terminal 200 and 210 and the group list management server 300 when, for example, they attempt to establish a session. The PoC server 500 offers application-level network functions for PoC services. The maintenance console 600 is used by an operator to manage data related to group lists by interacting with the group list management server 300.

In PoC communication sessions, the PoC terminals 200 and 210 use an ordinary connection path over the mobile phone network. That is, they communicate through the cellular station 40, mobile communications network 20, and mobile carrier private IP network 30 under the control of the PoC server 500. When, on the other hand, the PoC terminals 200 and 210 need to interact with the PoC data transmission device 100, the aforementioned wireless LAN in the area A1 is used under the control of the PoC data transmission device 100.

### Hardware Platform

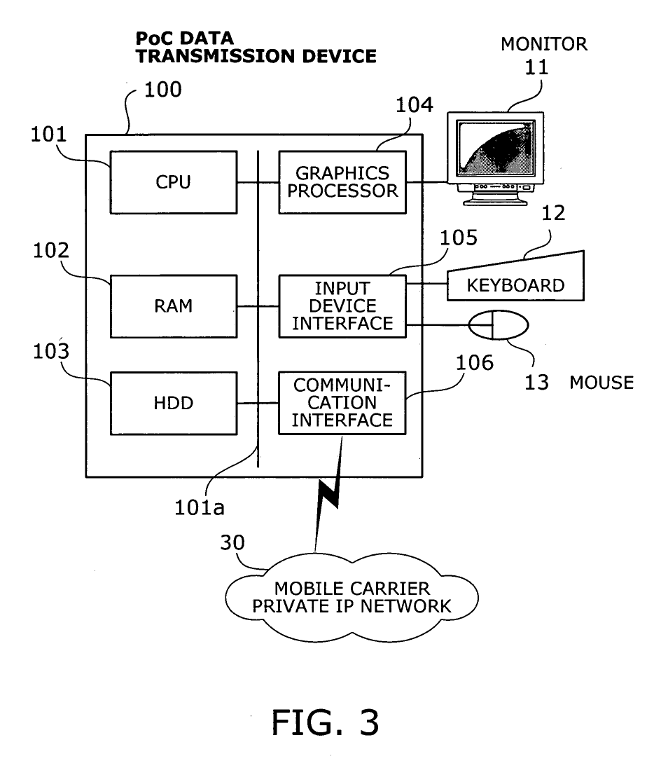

To perform the tasks of grouping PoC terminals, the PoC data transmission device 100 is implemented on a hardware described below. FIG. 3 shows an example hardware platform for the PoC data transmission device 100. The illustrated PoC data transmission device 100 has the following functional elements: a central processing unit (CPU) 101, a random access memory (RAM) 102, a hard disk drive (HDD) 103, a graphics processor 104, an input device interface 105, and a communication interface 106. The CPU 101 controls the entire computer system, interacting with other elements via a bus 101a.

The RAM 102 serves as temporary storage for the whole or part of operating system (OS) programs and application programs that the CPU 101 executes, in addition to other various data objects manipulated at runtime. The HDD 103 stores program and data files of the operating system and various applications.

The graphics processor 104 produces video images in accordance with drawing commands from the CPU 101 and displays them on a screen of an external monitor 11 coupled thereto. The input device interface 105 is used to receive signals from external input devices, such as a keyboard 12 and a mouse 13 coupled thereto. Those input signals are supplied to the CPU 101 via the bus 101a. The communication interface 106 is connected to the mobile carrier private IP network 30, allowing the CPU 101 to exchange data with other network entities including the group list management server 300, SIP server 400, PoC server 500, and maintenance console 600.

The computer described above serves as a hardware platform for realizing the processing functions of the present embodiment. While FIG. 3 shows a PoC data transmission device 100, a similar hardware structure would also be applied to the group list management server 300, SIP server 400, PoC server 500, and maintenance console 600.

### PoC Data Transmission Device

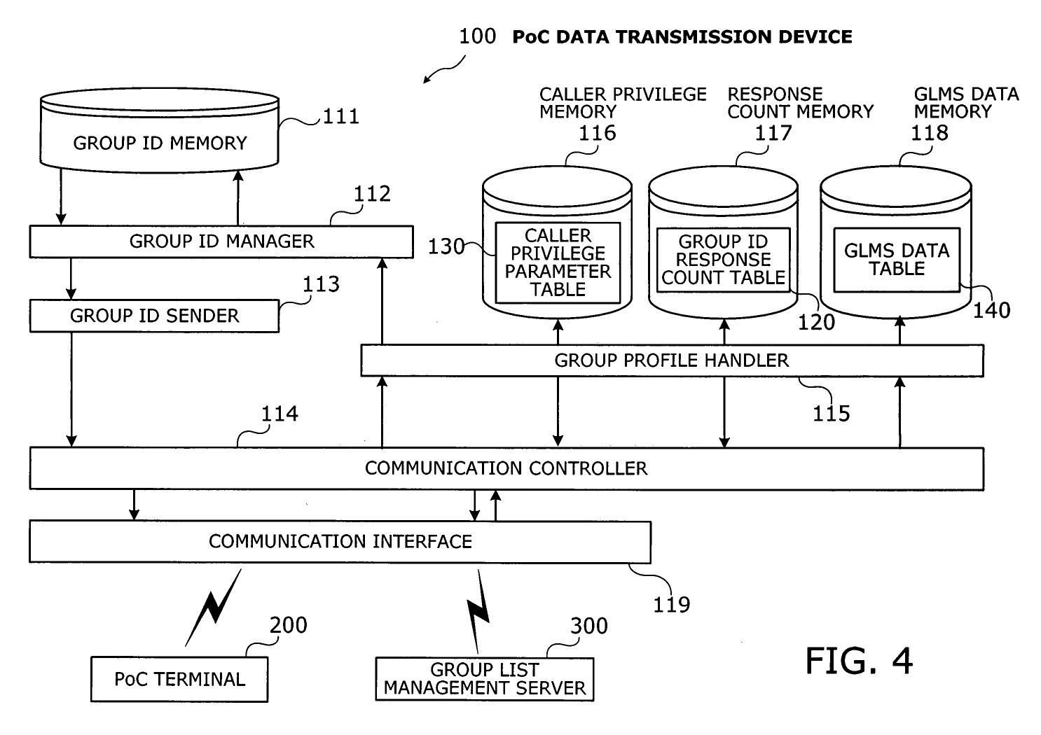

The system elements shown in FIGS. 2 and 3 will now be described in detail below. Referring first to a block diagram of FIG. 4, the PoC data transmission device 100 has, among others, the following functional elements: a group ID memory 111 storing group IDs, a group ID manager 112, a group ID sender 113, a communication controller 114, a group profile handler 115, a caller privilege memory 116, a response count memory 117, a GLMS data memory 118, and a communication interface 119.

The group ID manager 112 manages group IDs stored in the group ID memory 111. If there arises a request for registration of a new group ID, the group ID manager 112 adds that ID to the group ID memory 111. If, on the other hand, there is a request for deletion of an existing group ID, it removes that ID from the group ID memory 111. The group ID manager 112 also retrieves a group ID out of the group ID memory 111 as necessary for delivery to the group ID sender 113. The group ID sender 113 passes such group IDs to the communication controller 114 upon receipt of a group ID send command.

The communication controller 114 exchanges various data messages with the group list management server 300 over a wireless or wired channel that the communication interface 119 offers. The communication controller 114 receives, for example, a group ID acknowledgment from the PoC terminals 200. It also receives group IDs, caller privilege parameters, and response count threshold parameters from the group list management server 300, in addition to its IP address. The received information is passed to the group profile handler 115. The communication controller 114 routes various notifications to their destinations when they are received from the group ID sender 113 and group profile handler 115.

The group profile handler 115 sends a group profile registration request or a group profile deletion request to the group ID manager 112 when it receives a specific group ID. The group profile handler 115 also passes received caller privilege parameters to the caller privilege memory 116, and received group response counts to the response count memory 117. The IP address of the group list management server 300 is directed to the GLMS data memory 118 when it arrives at the group profile handler 115. If required, the group profile handler 115 retrieves information stored in the memories 116 to 118 and passes the retrieved information to the communication controller 114. Further, the group profile handler 115 outputs a caller privilege notice to the communication controller 114 when a group ID is received.

The caller privilege memory 116 contains a caller privilege management table 130 to store caller privilege parameters. The response count memory 117 contains a group ID response counter table 120 to store response count threshold parameters. The GLMS data memory 118 contains a GLMS data table 140 to store information on the group list management server 300.

The communication interface 119 provides the PoC data transmission device 100 with a capability of communicating with other network entities including the PoC terminals 200 and group list management server 300.

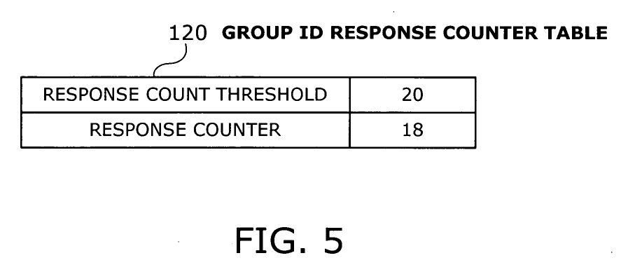

FIG. 5 shows an example of a group ID response count table stored in the response count memory 117. This group ID response counter table 120 has two data fields titled “Response Count Threshold” and “Response Counter.”

The response count threshold field stores a response count threshold that is given as a response count threshold parameter. The response counter field shows the number of responses received from PoC terminals 200 with respect to the group ID that the PoC data transmission device 100 has been transmitting. In the example table of FIG. 5, the response count threshold is set to 20, and the response counter currently holds a value of 18.

Each time a group ID acknowledgment is received from PoC terminals 200, the communication controller 114 requests the group profile handler 115 to increment the response counter. When the new response count equals the given response count threshold, the group profile handler 115 sends a threshold crossing notice to the communication controller 114. When there is a notice of a new group ID from the group list management server 300, the group profile handler 115 clears the response counter to zero.

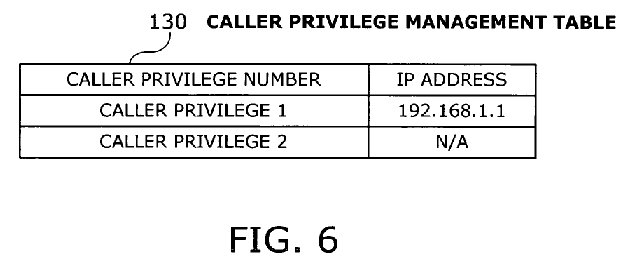

FIG. 6 shows a caller privilege management table stored in the caller privilege memory 116. This caller privilege management table 130 has the following columns: “Caller Privilege Number” and “IP Address.” Each row (i.e., a set of associated data fields) of the table 130 constitutes a single record.

The caller privilege number field stores an identifier, such as a nickname, that can be used to identify a caller privilege (i.e., a right to initiate push-to-talk sessions) attached to a particular PoC terminal 210. The caller privilege management table 130 of FIG. 6 shows two example values, “caller privilege 1” and “caller privilege 2,” for this field. The IP address field contains the IP address of a privileged PoC terminal. The example of FIG. 6 includes an entry with a value of “192.168.1.1” for “caller privilege 1.” This is a table entry for the PoC terminal 210. The other entry is blank since “caller privilege 2” is unregistered.

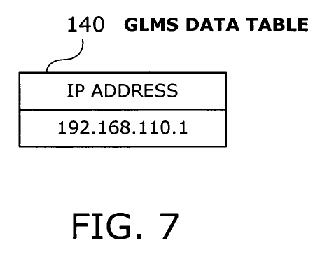

FIG. 7 shows a GLMS data table. This GIMS data table 140 has a data field titled “IP Address” to record the IP address of the group list management server 300. FIG. 7 shows an IP address value of “192.168.110.1” as an example.

### PoC Terminal

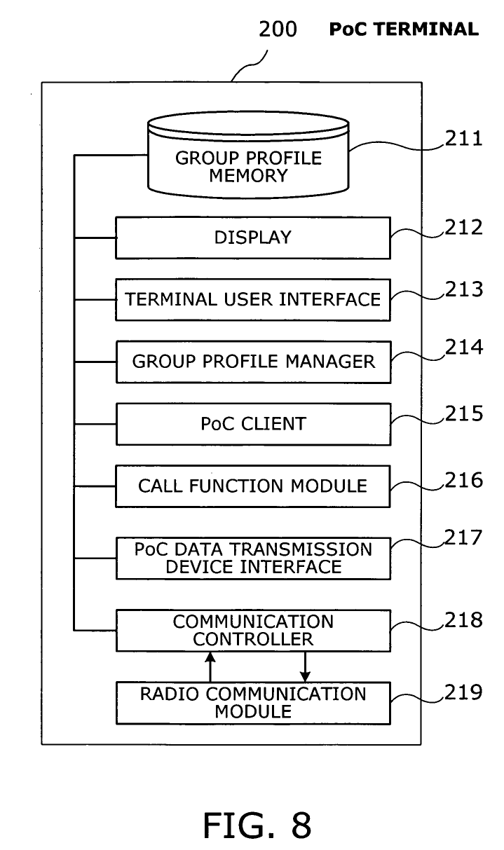

FIG. 8 is a block diagram of a PoC terminal. The illustrated PoC terminal 200 has, among others, a group profile memory 211, a display 212, a terminal user interface 213, a group profile manager 214, a PoC client 215, a call function module 216, a PoC data transmission device interface 217, a communication controller 218, and a radio communication module 219.

The group profile memory 211 stores group IDs supplied from the PoC data transmission device 100, together with group name parameters (described later) supplied from the group list management server 300. The display 212 displays those group IDs and group name values as necessary. The terminal user interface 213 accepts keypad inputs from the user. The group profile manager 214 is responsible for registration and deletion of group ID entries and group name entries in the group profile memory 211. The PoC client 215 offers functions of controlling push-to-talk sessions. The call function module 216 enables the user to talk to other users.

The radio communication module 219 provides two interface functions: one for exchanging various messages with the PoC data transmission device 100, and the other for mobile communication via a cellular station. Via this radio communication module 219, the communication controller 218 transmits and receives signals to/from the PoC data transmission device 100 or over the mobile communications network 20.

The PoC data transmission device interface 217 sends a group ID registration request or a group ID deletion request to the group profile manager 214 upon receipt of a group ID from the communication controller 218. The PoC data transmission device interface 217 also sends a group ID acknowledgment to the PoC data transmission device 100 upon receipt of a group ID acknowledgment command.

In operation, the radio communication module 219 receives a message from the PoC data transmission device 100. This message is passed to the communication controller 218. The communication controller 218 determines whether the message is a group ID. If it is, the received group ID is passed to the PoC data transmission device interface 217. The PoC data transmission device interface 217 then forwards the received group ID to the group profile manager 214 for storage in the group profile memory 211. This group ID can now be output to the display 212 as a group available for participation. The user may want to join a specific group selected from among those shown on the display 212. If this is the case, the PoC client 217 issues an enrollment request specifying the selected group ID to the group list management server 300 over the mobile communications network 20 via the communication controller 218 and radio communication module 219.

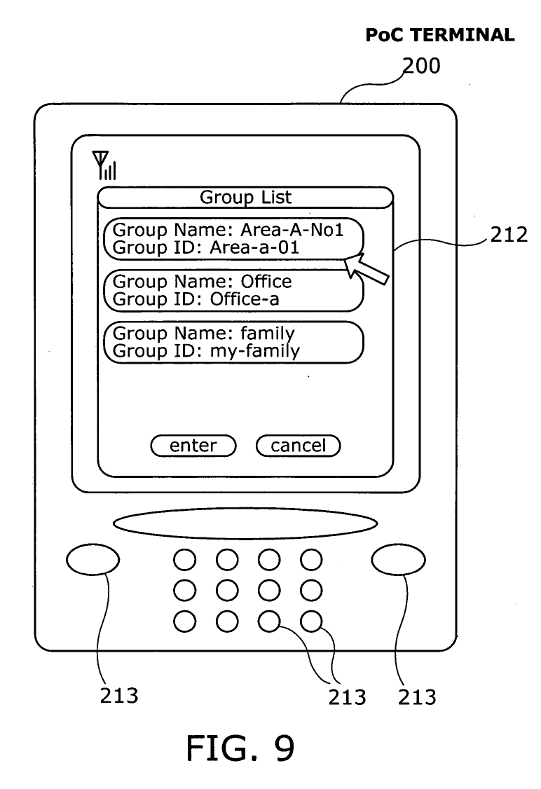

FIG. 9 is a plan view of the PoC terminal 200. As can be seen from FIG. 9, the display 212 shows the following three group names: “Area-A-No1,” “Office,” and “Family.” The user is allowed to enroll in one of those groups. Suppose, for example, that the user wishes to participate in a group with a group name of “Area-A-No1.” The user selects this group by manipulating the terminal user interface 213. The selection causes a group ID acknowledgment command to be sent to the PoC data transmission device interface 217. The PoC data transmission device interface 217 then transmits a group ID acknowledgment to the PoC data transmission device 100 via the communication controller 218 and radio communication module 219.

### Group List Management Server

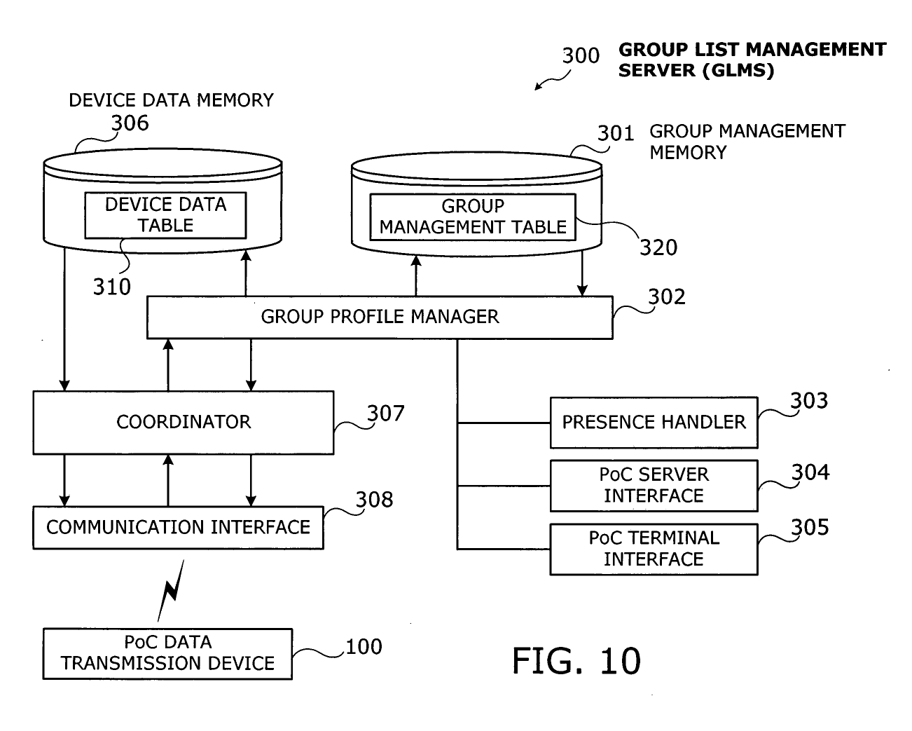

FIG. 10 is a block diagram of the group list management server 300. The illustrated group list management server 300 has, among others, the following elements: a group management memory 301, a group profile manager 302, a presence handler 303, a PoC server interface 304, a PoC terminal interface 305, a device data memory 306, a coordinator 307, and a communication interface 308.

Briefly these elements have the following functions: The group management memory 301 stores information about groups. The group profile manager 302 creates new group IDs, besides managing the information related to existing groups. The presence handler 303 provides a PoC terminal 200 with available group IDs and user list that it manages, when a presence management request is received. The PoC server interface 304 forwards the group information and user list that it manages to the PoC server 500 upon request therefrom. The PoC terminal interface 305 updates its local group information upon receipt of a request from PoC terminals 200 for creation of a new group, registration to a group, deregistration from a group, or deletion of an existing group. The device data memory 306 stores information about the PoC data transmission device 100.

More specifically, the group management memory 301 maintains a group management table 320 for management of information about groups. The PoC terminal interface 305 outputs to the group profile manager 302 a request for updating this group management table 320, upon receipt of a group participation notice from a PoC terminal 200. The device data memory 306, on the other hand, has a device data table 310 to manage the information about the PoC data transmission device 100. The items stored in this device data table 310 include group IDs, response count threshold parameters, and caller privilege parameters.

The coordinator 307 requests the group profile manager 302 to produce a new group ID when a threshold crossing notice from the PoC data transmission device 100 arrives at the communication interface 308. The coordinator 307 is also responsive to a group profile transmission command from the group profile manager 302. This command causes the coordinator 307 to retrieve a specified group ID, caller privilege parameter, and response count threshold parameter from the device data table 310 and send them to the PoC data transmission device 100 via the communication interface 308. Further, the coordinator 307 sends a new group ID to the PoC data transmission device 100 via the communication interface 308 when a new group ID transmission command is received. The communication interface 308 provides the group list management server 300 with a capability of communicating with the PoC data transmission device 100.

The group profile manager 302 produces and stores a new group ID in the device data table 310 and group management table 320 if so requested. Once registered, the new group ID is ready to be sent out from the coordinator 307 to the PoC data transmission device 100 under the control of the group profile manager 302. The group profile manager 302 also updates the group management table 320 if so requested, and initiates transmission of a group name (described later) to PoC terminals 200.

### Group Profile

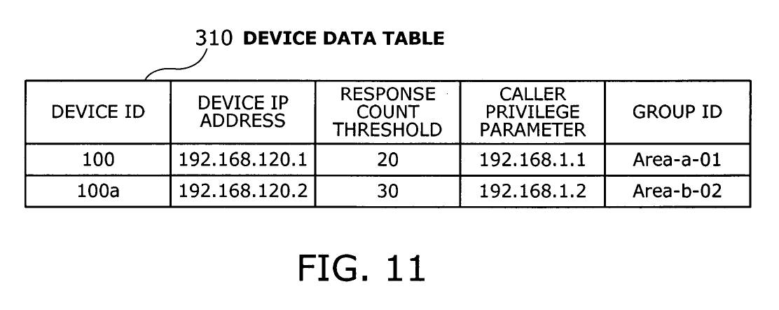

FIG. 11 shows an example of the device data table 310. The device data table 310 is used to manage and store the information about which group ID to distribute. In the case where there are two or more PoC data transmission devices (e.g., PoC data transmission devices 100 and 100a in FIG. 11), the device data table 310 stores the above information for each PoC data transmission device.

Specifically, the device data table 310 has the following data fields: “Device ID,” “Device IP Address,” “Response Count Threshold,” “Caller Privilege Parameter,” and “Group ID.” Each row (i.e., a set of associated data fields) of the table 310 constitutes a single entry corresponding to a particular PoC data transmission device.

The device ID field contains a serial number or a unique code to distinguish each PoC data transmission device 100 from others. The device IP address field shows the IP address of the corresponding PoC data transmission device 100 for use by the group list management server 300 in transmitting group IDs. The response count threshold field indicates a threshold used in creating a new group ID. Specifically, a new group ID is produced when the number of responses with respect to a specific group ID has reached the specified threshold. The caller privilege parameter field stores the IP address of a PoC terminal to which a caller privilege will be given. The group ID field stores a group ID that will appear on the display 212 of each user's PoC terminal. The value of this group ID field is given in the form of a group URI as will be described later.

In the example of FIG. 11, the device data table 310 shows that one PoC data transmission device 100 can be reached at the IP address of “192.168.120.1,” that the response count threshold is set to 20, that a caller privilege is given to a PoC terminal that can be reached at “192.168.1.1,” and that the group ID is currently set to “Area-a-01.” It also shows that another PoC data transmission device 100a has an IP address of “192.168.120.2,” that the response count threshold is set to 30, that a caller privilege is given to the PoC terminal with an IP address of “192.168.1.2,” and that the group ID is currently set to “Area-b-02.”

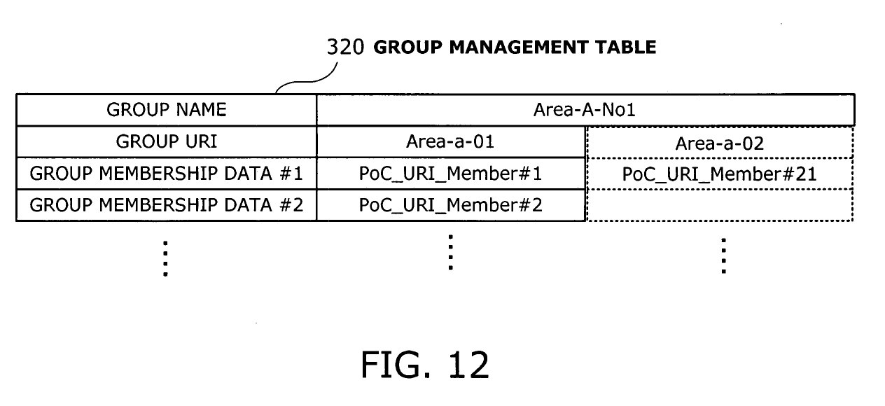

FIG. 12 shows an example of the device data table 320. This group management table 320 has the following rows: “Group Name,” “Group URI,” “Group Membership Data 1,” “Group Membership Data 2,” and so on. A set of vertically aligned data fields constitute a single entry of the table 320.

The group name field contains an area identifier, building name, attraction name, or the like. The content of this field will appear on the display 212 of a PoC terminal, alongside the group ID of a particular group, providing supplemental information for the user to understand what group it is. The group URI fields contains a uniform resource identifier (URI), or a resource address used to perform a group call under the control of the group list management server 300.

The group membership data fields show a collection of URIs of PoC terminals 200 that constitute a particular group. Those PoC terminals 200 have received a group ID in the coverage area of the PoC data transmission device 100 and sent a response to the group list management server 300 for enrollment in the group. The group membership data in the group management table 320 is defined and updated according to those requests from the group profile manager 302.

FIG. 12 shows that one group defined under the group name of “Area-A-No1” is identified by a URI of “Area-a-01.” When two users, Member#1 and Member#2, join this group, the corresponding group membership data fields will be filled with their respective URIs, i.e., PoC_URI_Member#1 for the first member, and PoC_URI_Member#2 for the second member.

FIG. 12 also shows another entry surrounded by the dotted line. This entry is an example of a new group ID which would be created in the future. Specifically, that new group, if created, will have a URI of “Area-a-02.” When a user, Member#21, joins this group “Area-a-02,” the URI of that member, “PoC_URI_Member#21,” will be entered to the first group membership data field.

### Initial Sequence

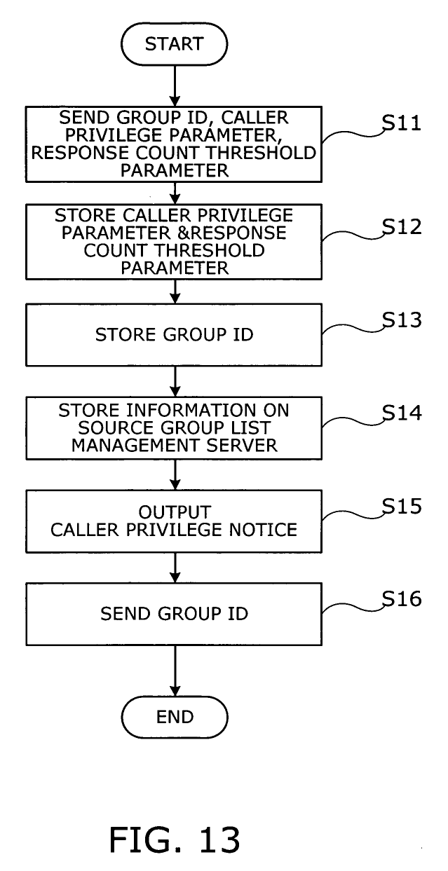

FIG. 13 is a flowchart showing an initial sequence that the PoC data transmission system 10 follows. This process starts with the transmission of a group ID, caller privilege parameter, and response count threshold parameter from the group list management server 300 to the PoC data transmission device 100 (step S11). The group profile handler 115 receives those parameters via the communication interface 119 and communication controller 114. The group profile handler 115 then issues a group ID registration request to the group ID manager 112, while saving the received caller privilege parameter and response count threshold in the caller privilege memory 116 and response count memory 117, respectively (step S12). The group ID manager 112 saves the group ID in the group ID memory 111 (step S13). The group profile handler 115 further obtains the IP address of the source group list management server and saves it in the GLMS data memory 118 (step S14). These steps S13 and S14 may be executed simultaneously, or alternatively, S14 first and S13 second.

With respect to the received group ID, the group profile handler 115 now issues a caller privilege notice to the communication controller 114 (step S15). Subsequently the group ID manager 112 requests the group ID sender 113 to send the group ID. Accordingly, the group ID sender 113 commands the communication controller 114 to begin broadcasting of the group ID (step S16).

The above initial sequence enables the PoC data transmission device 100 to send a group ID in area A1 and to get ready to assign a group for PoC terminals 200 moving into area A1.

### Grouping Operation (First Embodiment)

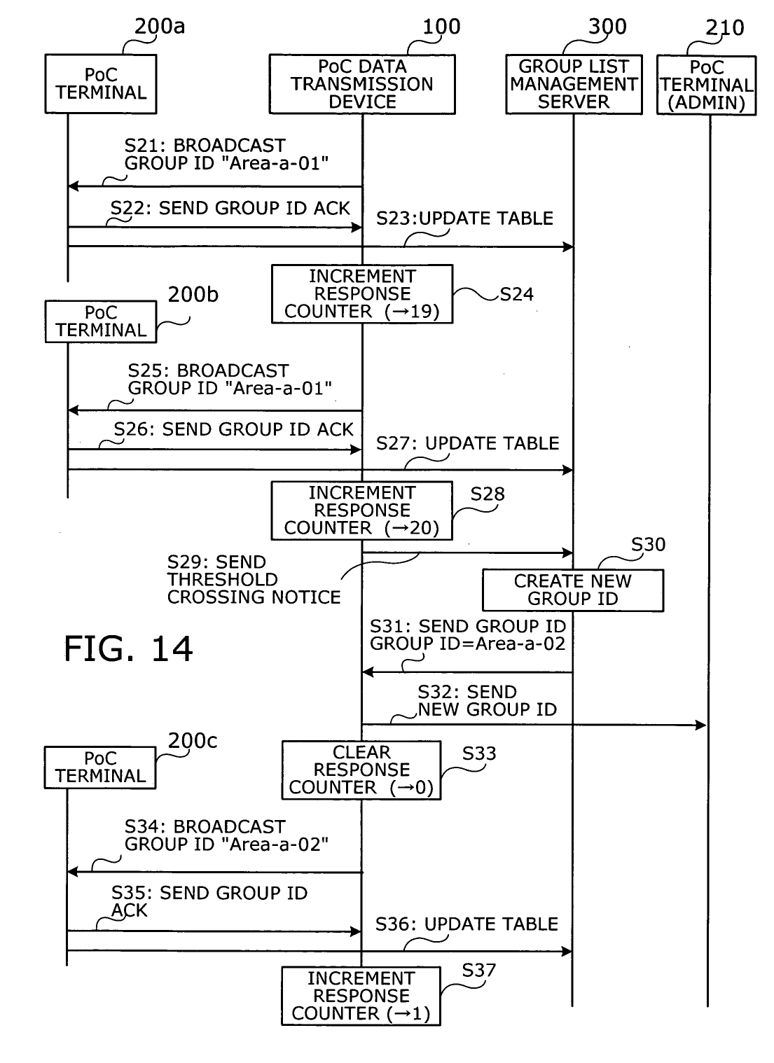

FIG. 14 shows an operation sequence of a PoC data transmission system according to a first embodiment of the present invention. It is assumed in FIG. 14 that the group list management server 300 has already provided the PoC data transmission device 100 with the following parameters:
group ID: Area-a-01
caller privilege parameter: 192.168.1.1
response count threshold parameter=20
   It is also assumed that the response count has increased to 18, meaning that 18 PoC terminals have returned a response to the group ID “Area-a-01.” Suppose now that three new PoC terminals 200a, 200b, and 200c arrive at area A1 in that order.

Upon entering area A1, the first PoC terminal 200a receives a group ID of “Area-a-01” from the PoC data transmission device 100 via a wireless LAN channel (step S21). This allows the PoC terminal 200a to display the received group ID “Area-a-01” on its display 212, prompting the user to select that group for participation. If the user wishes to join the group, then he/she selects “Area-a-01” and hits an enter button, which causes his PoC terminal 200a to return a group ID acknowledgment to the PoC data transmission device 100 via the wireless LAN (step S22). The PoC terminal 200a also sends a registration request message including the selected group ID to the group list management server 300 via the mobile communications network 20. The group list management server 300 accepts this access from the PoC terminal 200a and updates the group management table 320 by adding the information on the PoC terminal 200a to a group membership data field corresponding to the URI used in the access (step S23).

Upon receipt of the group ID acknowledgment, the PoC data transmission device 100 increments the response counter (step S24) and determines whether the response count has reached the given response count threshold, 20. The response count is 19 at the present moment of step S24. Since this is below the threshold, the PoC data transmission device 100 sends no threshold crossing notice.

Another PoC terminal 200b now enters area A1 and receives a group ID of “Area-a-01” (step S25). The PoC terminal 200b then returns a group ID acknowledgment back to the PoC data transmission device 100 (step S26) and registers itself with the group list management server 300 (step S27) in the same way as steps S22 and S23 described above. The PoC data transmission device 100 then increments the response counter and determines whether the count has reached the response count threshold (step S28). Step S28 results in a new response count of 20, which is equal to the specified response count threshold. The PoC data transmission device 100 thus sends a threshold crossing notice to the group list management server 300 in order to obtain a new group ID (step S29). Upon receipt of this threshold crossing notice, the group list management server 300 creates a new group ID “Area-a-02” (step S30) and sends it back to the PoC data transmission device 100 (step S31). The PoC data transmission device 100 receives and registers the new group ID. It also sends the new group ID to the privileged PoC terminal 210 (step S32). The PoC data transmission device 100 subsequently clears the response counter to zero (step S33) and begins broadcasting the new group ID.

Yet another PoC terminal 200c then roams into area A1 and receives the new group ID (step S34). The PoC terminal 200c then returns a group ID acknowledgment for the new group ID back to the PoC data transmission device 100 (step S35). The user of the PoC terminal 200c joins the new group, which causes the group list management server 300 to update its group management table 320 (step S36) as in step S23. Upon receipt of the group ID acknowledgment, the PoC data transmission device 100 increments the response counter (step S37). The third PoC terminal 200c is now a member of the new group with a group ID of “Area-a-02.” The group list management server 300 and PoC data transmission device 100 will handle other incoming PoC terminals, if any, by repeating the above-described steps.

The specific information about each group member terminal is collected in the way described above. The administrator, i.e., the owner of the PoC terminal 210, specifies a desired group as necessary to initiate a PoC talk session with all PoC terminals 200 belonging to that group. This talk session allows one-to-many communication between the administrator PoC terminal 210 and the other PoC terminals 200 in the group, while it is not allowed for the users of the PoC terminals 200 to talk with each other. The administrator can therefore deliver necessary information to the users of other PoC terminals 200.

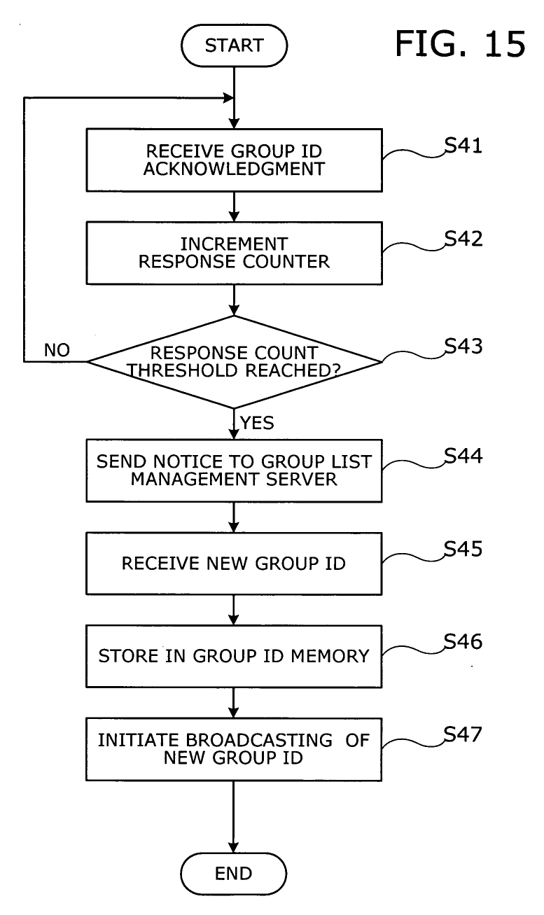

Referring now to the flowchart of FIG. 15, the following will describe in detail how the PoC data transmission device 100 behaves when a PoC terminal 200 has roamed into area A1.

When a group ID acknowledgment is transmitted from a PoC terminal 200, the group profile handler 115 first receives it through the communication interface 119 and communication controller 114 (step S41). The group profile handler 115 then increments a corresponding response counter in the response count memory 117 (step S42) and checks the resulting count as to whether it has reached a predetermined response count threshold stored in the response count memory 117 (step S43).

If the threshold is not reached (“NO” at step S43), then the group profile handler 115 returns to a wait state after updating a relevant entry of the group ID response counter table 120 in the response count memory 117. If, on the other hand, the threshold is reached (“YES” at step S43), the group profile handler 115 transmits a threshold crossing notice, or a new group ID registration request, toward the group list management server 300 via the communication interface 119 and communication controller 114 (step S44). This notice causes the group list management server 300 to create a new group ID and sends it to the PoC data transmission device 100 (step S45). The PoC data transmission device 100 saves the received new group ID in its group ID memory 111 (step S46) and then initiates broadcasting of the new group ID (step S47).

As can be seen from the above explanation, the PoC data transmission system 10 employs a PoC data transmission device 100 that creates a new group ID according to the number of participating PoC terminals 200 that have returned an acknowledgment message in response to a specific group ID.

In the case where many groups exist in the same system, the group list management server 300 manages them individually to permit easy and reliable grouping operations. Suppose, for example, that a PoC data transmission system 10 is applied to a large amusement park with many attractions. The PoC data transmission system 10 is used to control waiting guests at each attraction. A person in charge of management of an attraction has a privileged PoC terminal 210 to guide the next group of guests in a queue by calling them through PoC facilities.

More specifically, a PoC data transmission device 100 is placed near the entrance of an attraction building. Guests who wish to enter the attraction approach the entrance, allowing their PoC terminals 200a to 200c to receive information from the PoC data transmission device 100. The guests operate their PoC terminals 200a to 200c to make a registration (i.e., a reservation for the attraction), which means that they sign up for a group of waiting guests. The attraction manager is involved in every such group as a special member privileged to initiate a talk and thus allowed to know how many groups of guests are waiting for the attraction that he/she manages.

The present embodiment can be applied to amusement park attractions in the above-described way. Advantageously it enables the attraction manager to divide his/her waiting guests into appropriately-sized groups without the need for counting them for himself/herself. Since every guest bears a PoC terminal 200, the attraction manager can page a particular group of guests, regardless of their physical locations, by initiating a PoC talk session for that group. It is also advantageous that the waiting guests need not to queue up for entry to an attraction, but can go anywhere in the park as long as their PoC terminals can be reached through the wireless facilities. While the number of waiting quests may vary with time, the present embodiment makes it easy for the attraction manager to handle the queue.

The identifiers of PoC terminals 200 may be checked at the time of entry to an attraction, permitting the manager to know how many guests have entered actually. The guests who have passed the entry gate may be removed from the PoC group membership. This enables the manager to focus on the guests waiting outside the gate.

The present embodiment of the invention is, of course, not limited to the above application. While the above-described embodiment generates serial numbers for group IDs, it is also possible, for example, to configure the proposed PoC data transmission device to produce a new group ID by concatenating a timestamp to an area-specific group ID supplied from a group list management server. This alternative group ID structure allows users to know when each new group ID was created.

### Grouping Operation (Second Embodiment)

This section will describe a PoC data transmission system 10 according to a second embodiment of the present invention. The following discussion focuses on its difference from the first embodiment, affixing like reference numerals to like elements.

According to a second embodiment, the PoC data transmission system 10 lets its PoC data transmission device 100 create new group IDs, as opposed to the first embodiment, in which the group list management server 300 generates them. More specifically, the group profile handler 115 in the PoC data transmission device 100 is designed to request the group ID manager 112 to create a new group ID, instead of issuing a threshold crossing notice. The group profile handler 115 in the second embodiment is also responsible for registering created group IDs with the group list management server 300.

The coordinator 307 in the group list management server 300 is modified to receive a group ID registration request, instead of a threshold crossing notice, and update a group management table 320 in the group management memory 301 through the group profile manager 302.

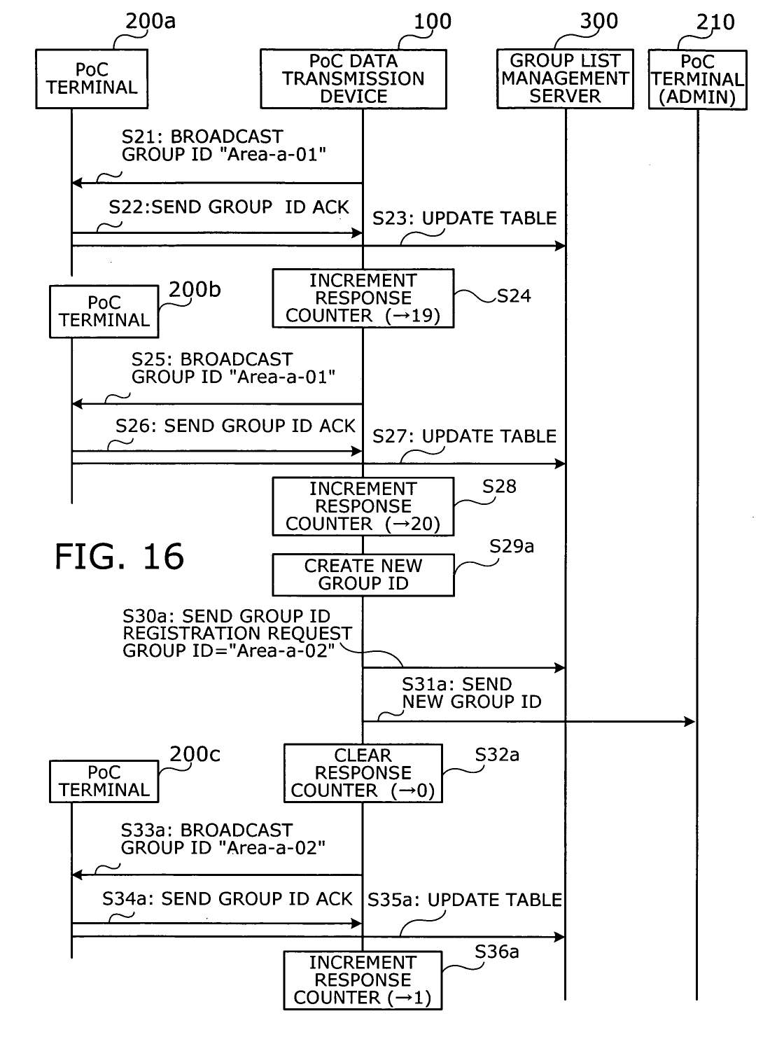

FIG. 16 shows an operation sequence of the PoC data transmission system 10 according to the second embodiment outlined above. Steps S21 to S28 of FIG. 16 will not be explained here again since they are identical to the corresponding steps of FIG. 14. See the description of the first embodiment for details of those steps. The PoC data transmission system 10 of the second embodiment operates at S29a and subsequent steps as follows:

Since the response count has reached the threshold at step S28, the PoC data transmission device 100 creates a new group ID by modifying an existing group ID (step S29a. The PoC data transmission device 100 then sends a group ID registration request for “Area-a-02” to the group list management server 300 (step S30a), as well as sending the new group ID to the privileged PoC terminal 210 (step S31a). For the subsequent steps S32a to S36a, see the description of steps S33 to S37 in FIG. 14. The above-described PoC data transmission system 10 of the second embodiment offers the same advantages as the first embodiment does.

### Possible Modifications to Embodiments

The preceding sections have described in detail two preferred embodiments of the invention. The present invention, however, should not be limited to those embodiments. For example, two or more PoC data transmission devices may be deployed in a single area, while there is only one PoC data transmission device 100 in area A1 in the foregoing embodiments. In this case, the group list management server 300 provides those PoC data transmission devices with different group IDs, allowing PoC terminals 200 to receive different group names and IDs from each PoC data transmission device.

In the foregoing embodiments, a mobile carrier private IP network 30 is used to connect the PoC data transmission device 100 to the group list management server 300, SIP server 400, PoC server 500, and maintenance console 600. Alternatively, this mobile carrier private IP network 30 may be replaced with an enterprise IP network or the Internet, or a wireless LAN linked to them. The PoC data transmission device 100 functions in this case as a client of a wireless LAN access point in the network. Specifically, the PoC data transmission device 100 will be given a private address from the access point device for use in Internet connection.

Also, while the foregoing embodiments use URIs for group IDs, it is not intended to limit the present invention to that specific choice of parameter type.

### PoC Standard Documents

The PoC terminals 200 and 210 in the above embodiments have standard protocol functions to provide PoC services. They use, for example, SIP, Real-time Transport Protocol (RTP), and RTP Control Protocol (RTCP) to realize PoC talk sessions between group members. The following is a list of PoC reference documents provided by the Open Mobile Alliance (OMA), a standardization organization for mobile data services. The contents of those standard documents are incorporated herein by reference.

(1) Push to talk over Cellular (PoC)—Architecture Draft Version 1.0, 18 January 2005 (Open Mobile Alliance OMA-AD_PoC-V1_{—}0-2005018-D)

(2) Presence Requirements Version 1.0, 19 August 2004 (Open Mobile Alliance OMA-RD_Presence-V1_{—}0-20040819)

(3) Group Management Requirements Candidate Version 1.0, 30 Sep. 2004 (Open Mobile Alliance OMA-RD GM-V10-20040930-C)

(4) Stage 2—Presence using SIMPLE Draft Version 1.0, 30 Oct. 2004 (Open Mobile Alliance OMA-PAG-SIMPLE-AD-V1_{—}1_{—}0_{—}20041030-D)

### Computer-Readable Storage Media

The functions of the above-described PoC data transmission device 100 are implemented as a computer application. That is, the present invention can be realized by running a computer program designed for the purpose of PoC data transmission. This PoC data management program includes a series of instructions describing what the PoC data transmission device 100 is supposed to do. A computer system executes those program instructions to provide the intended processing functions of the present invention.

The PoC data management program is stored in a computer-readable medium for the purpose of storage and distribution. Suitable computer-readable storage media include magnetic storage media, optical discs, magneto-optical storage media, and solid state memory devices. Magnetic storage media include hard disk drives (HDD), flexible disks (FD), and magnetic tapes. Optical disc media include digital versatile discs (DVD), DVD-RAM, compact disc read-only memory (CD-ROM), CD-Recordable (CD-R), and CD-Rewritable (CD-RW). Magneto-optical storage media include magneto-optical discs (MO).

Portable storage media, such as DVD and CD-ROM, are suitable for the distribution of PoC data management programs. Network-based distribution of software programs is also possible, in which case several master program files are made available on a server computer for downloading to other computers via a network.

A computer stores necessary software components of the PoC data management program in its local storage unit, which have previously been installed from a portable storage media or downloaded from a server computer. The computer executes the program read out of the local storage unit, thereby performing the programmed functions. As an alternative way of program execution, the computer may execute programs, reading out program codes directly from a portable storage medium. Another alternative method is that the user computer dynamically downloads programs from a server computer when they are demanded and executes them upon delivery.

### CONCLUSION

The present invention provides a PoC data transmission device that sends a group profile to user terminal devices in a predetermined area, counts responses returned from those terminals that have received the group profile, and creates a new group each time a predetermined number of responses are received. This mechanism dynamically produces new groups according to the number of participating terminals. Group profiles are uniquely defined for individual groups, thus enabling a plurality of groups in a single system to be distinguished from each other.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A device for distributing data for setting up push-to-talk sessions, the device comprising:
a data transmitter that broadcasts a group profile repetitively in a prescribed area, the group profile being a set of parameters that prompt terminals in the prescribed area to send unique identifiers thereof to join a push-to-talk session; and
a counter for counting the number of responses returned from the terminals;
wherein said data transmitter broadcasts a new group profile if the number of responses has reached a predetermined threshold.

2. The device according to claim 1, further comprising a group profile generator that generates the new group profile.

3. The device according to claim 1, wherein:
an administration terminal having an administrator privilege is provided in the prescribed area; and
the administration terminal receives information about member terminals of a group and is allowed to communicate with said member terminals.

4. The device according to claim 3, wherein:
the administration terminal is allowed to communicate with every member terminal of the group in the push-to-talk session; and
the member terminals is only allowed to communicate with the administration terminal in the push-to-talk session.

5. The device according to claim 1, wherein the new group profile is provided from a group list management server that is connected to the device via a network.

6. A method for distributing data for setting up push-to-talk sessions, the method comprising:
broadcasting a group profile repetitively in a prescribed area, the group profile being a set of parameters that prompt terminals in the prescribed area to send unique identifiers thereof to join a push-to-talk session;
counting the number of responses returned from the terminals; and
broadcasting a new group profile if the number of responses has reached a predetermined threshold.

7. A group list management server for managing a group of terminals participating in a push-to-talk session, wherein the group list management server manages information provided by member terminals of each group in response to a group profile that has been transmitted so as to prompt terminals in a prescribed area to send unique identifiers thereof to join a push-to-talk session.

8. The group list management server according to claim 7, the group list management server generating and sending a new group profile if the number of responses returned from the terminals has reached a predetermined threshold.
